(19) United States
(12) Patent Application Publication
(10) Pub. No.: US 2018/0170508 A1
(43) Pub. Date: Jun. 21, 2018

(54) LIFT GENERATING FUSELAGE FOR AIRCRAFT

(71) Applicant: Rajan J BHATT, Baroda (IN)

(72) Inventor: Rajan J BHATT, Baroda (IN)

(21) Appl. No.: 15/746,444

(22) PCT Filed: Jul. 26, 2016
(86) PCT No.: PCT/IN2016/050251

§ 371 Date: Jan. 22, 2018

(30) Foreign Application Priority Data
Jul. 27, 2015 (IN) 2448/MUM/2014

(51) Int. Cl. B64C 1/00; B64C 39/10

(52) U.S. Cl. CPC B64C 1/0009; B64C 2001/0045; B64C 39/10

(57) ABSTRACT

The present lift generating fuselage (1) for aircraft mainly comprises of: a novel aerofoil shaped fuselage (1A); or a novel aerofoil shaped fuselage body (2); and integral webs (3); or a novel aerofoil shaped fuselage body (2); integral webs (3) and overhead central wing (4).

### FIELD OF INVENTION

The present invention relates to a lift generating fuselage for aircraft. More particularly, the present invention relates to a lift generating fuselage for aircraft that maximizes the lift factor thereby significantly decreases the length of runway required for the take off of the aircraft, that enables the aircraft to land and takeoff directly from water surface making it an amphibious aircraft. Moreover, there exists a need to develop a lift generating fuselage for aircraft that keeps the aircraft airborne even at low speeds and also enables it to withstand bad weathers.

### BACKGROUND OF THE INVENTION

Fuselage is an aircraft's main body section that holds crew and passengers or cargo. That is, a fuselage is that part of an aircraft which houses the passenger compartment, the cock pit as well as the cargo and utilities chambers including cargo hold and the flight deck. It is generally of a tubular shape, tapering off at both the ends in to a conical shape. The nose cone or the front end cone is usually shorter and houses the flight deck and the avionics etc. The rear end cone is relatively longer and its taper is prominently on the bottom surface. The fuselage also serves to position control and stabilization surfaces in specific relationships to lifting surfaces, required for aircraft stability and maneuverability.

Said lifting surfaces mainly wings are responsible for generating lift and ultimately for the flight of the aircraft.

Lift is the force that directly opposes the weight of an airplane (most of the weight of the airplane or aircraft is of the fuselage carrying the passengers and the luggage) and holds the airplane in the air. Lift acts through the center of pressure of the object and is directed perpendicular to the flow direction.

Airplanes fly when the movement of air across their wings creates an upward force on the wings (and thus the rest of the plane) that is greater than the force of gravity pulling the plane toward the earth.

The faster that air moves through a space, the lower the air pressure; the slower it moves, the higher the pressure. Aircraft wings are designed to take advantage of that fact and create the lift force necessary to overcome the weight of the aircraft, and get airplanes off the ground. The undersides of wings are more or less flat, while their tops are curved so air moving around a wing has a longer way to travel over the top than it does underneath. The air going over the top moves faster than the air going underneath, and the air pressure above the wing thus is lower than it is under the wing, where slower moving air molecules bunch together. The pressure differential between the upper and the lower surface of the wing creates lift, and the faster the wing moves through the air, the greater the lift becomes, eventually overcoming the force of gravity upon the aircraft.

The existing or the conventional fuselage contributes to the weight and generates only the aerodynamic drag or the horizontal force acting against the direction of motion and practically fails to contribute to the lift generation or the generation of vertical force that tends to keep the aircraft airborne. Thus lift force required to keep the aircraft airborne is being generated mainly from the aircraft wings.

Further, due to the drag produced by the existing fuselage, the aircraft is required to attain higher speeds on the runway before it can become airborne and hence the distance or length on the run way required for take-off as well as landing also is high. Also, the thrust required for propelling the aircraft is high resulting in greater consumption of fuel. Hence, the aircraft has to carry more fuel to fly over a given distance with a given payload. This results in greater overall weight required to be lifted thus increasing the fuel consumption further. Due to the requirement of higher speeds & runway distances at the time of take off & landing the risk factor for occurrence of any mishap or an untoward incident increases. Also the airport requires longer runways, adding to the cost of infrastructure, maintenance and increased problem of security.

In addition, on an airplane, drag results from several major factors including skin friction: the friction between molecules of air and the airplanes surface, form drag which is fluid resistance of the airplane moving through the air; and induced drag where airflow near the tips of the wings is distorted causing swirling vortexes of air to form near the wing tips causing further drag. (Benson)

Wind shear is also a hazard for aircraft making steep turns near the ground. It is a particular problem for gliders which have a relatively long wingspan, which exposes them to a greater wind speed difference for a given bank angle. The different airspeed experienced by each wing tip can result in an aerodynamic stall on one wing, causing a loss of control accident

During bad weather conditions the turbulence of air causes extreme fluctuations of forces acting on the wing surface causing the wings to shake severely. Longer the wing more is the bending force experienced at the wing to fuselage junction. Thus the chances of fatigue failure occurring at the wing-fuselage intersection and resultant crash of the aircraft are high. Thus, the existing fuselages impart high risk of wing distortion and crashing of aircrafts in bad weather conditions.

Further, the conventional aircrafts have additional vertical stabilizer which is necessary to provide stability to the aircraft, to keep it flying straight. The vertical stabilizer keeps the nose of the plane from swinging from side to side, which is called yaw. However, the large size of said vertical stabilizer imposes extra constructional cost for the aircraft as well as it shall require heighted hanger at the airport adding high costs for the infrastructure of the airport. In addition, the high vertical tail also causes greater stresses at the tail to fuselage joint and so the consequential risk of warp and failure during turbulent atmospheric conditions are also high.

Moreover, the conventional fuselage has a circular cross section which gives limitations in terms of the effective volume of space that can be utilized for accommodating the passenger seating, cargo hold, flight deck as well as the utilities. Further, in the event of belly landing on water the conventional fuselage submerges to such depth in water that it is highly improbable for the aircraft to take off again from water surface.

Also, the aircrafts with conventional fuselage have higher take-off and landing speeds, which make them prone to various accidents including incident like tyre burst or skidding or inability to cope up with eventualities like unexpected obstruction etc. on the runway at the time of take off/landing.

Thus, there is a need to develop a lift generating fuselage for aircraft that maximizes the lift factor and thereby significantly decrease the takeoff and landing speeds as well as length of runway required for the take off/landing of the aircraft. Also a need exist to develop a lift generating fuselage for aircraft that enables the aircraft to land and takeoff directly from water surface making it an amphibious aircraft. Moreover, there exists a need to develop a lift generating fuselage for aircraft that keeps the aircraft airborne even at low speeds and efficiently withstands bad weathers.

### PRIOR ART AND ITS DISADVANTAGES

Currently, the conventional aircraft fuselage has a tubular or hollow pipe shape from front to back, tapering off into conical shape at front & rear ends. The current day aircraft configuration is shown in the FIG. 4A where in the fuselage is the central belly or the main body portion which houses the passenger compartment, the cock pit as well as the cargo and utilities chambers. Said fuselage suffers from various limitations as under:
1) It induces drag.
2) No lift generation by fuselage. So, it does not help in keeping the aircraft airborne.
3) require higher runway length to take-off
4) high cost of infrastructure required at airports for higher runway
5) higher maintenance and increased problem of security.
6) greater consumption of fuel.
7) greater overall weight required to be lifted thus increasing the fuel consumption further.
8) risk factor for occurrence of any mishap or an untoward incident are high.
9) imparts limitations in terms of the effective volume of space that can be utilized for accommodating the passenger seating, cargo hold, flight deck as well as the utilities.
10) not possible to take-off from water.

Attempts to address some of the above issues were made in past and a new aircraft architecture known as Flying Wing configuration was envisaged by Scientists A. L. Bolsunovsky and N. P. Buzoverya of Central Aerodynamic Institute, Moscow, Russia. According to them, one of the approaches to improving the efficiency of future airplanes is to increase their passenger capacity. This will enable reduction in direct operating costs (DOC) per passenger and also relieve congestion on large airports by decreasing the number of flights as depicted in the graph shown in FIG. 4B.

Said Flying Wing (shown in FIG. 4C) which was an attempt to blend the lift generating wing with a squarish rather than tubular shaped fuselage. However, for conventional airplanes with the concept of separating component functions, an increase in dimensions can lead to degradation of weight efficiency. The stated feature as well as the requirements of the airplane size dictated by the infrastructure of available airports can significantly limit maximum passenger capacity of a conventional airplane configuration. At the same time, increase of the airplane dimensions enables an entire payload or its portion to be accommodated in the wing and, thus, a Flying-Wing (FW) concept will become possible, where the component functions are integrated. The length of such an airplane is substantially less than that of a conventional airplane and the span of outboard wings can be reduced in operating on the ground by deflecting their tips upward. An increased structure depth of the center section makes it possible to increase the wing span with less weight penalties as compared with conventional airplanes and, thus, to increase the Flying Wing lift-to-drag (L/D) ratio. Although the Flying Wing architecture is still in development stage its biggest disadvantage is manufacturing complications as well as high specific fuel consumption due to low lift to drag ratios.

Thus, none of the prior arts could provide a lift generating fuselage for aircraft that maximizes the lift factor thereby significantly decreases the length of runway required for the take off/landing of the aircraft, that enables the aircraft to land and takeoff directly from water surface making it a amphibious aircraft. Moreover, neither of them could provide lift generating fuselage for aircraft that keeps the aircraft airborne and efficiently withstands bad weathers.

### OBJECTS OF THE INVENTION

Main object of the present is to provide a lift generating fuselage for aircraft that maximizes the lift to drag ratio thereby helps in keeping the aircraft airborne.

Another object of the present invention is to provide a lift generating fuselage for aircraft which significantly decreases the length of runway required for the take off/landing of the aircraft.

Yet another object of the present invention is to provide a lift generating fuselage for aircraft that enables the aircraft to land and takeoff directly from water surface making it an amphibious aircraft.

Yet another object of the present invention is to provide a lift generating fuselage for aircraft that enables the aircraft to land and takeoff at significantly lower speeds.

Yet another object of the present invention is to provide a lift generating fuselage for aircraft that has safer landing and take-off.

Yet another object of the present invention is to provide a lift generating fuselage for aircraft that stabilizes the aircraft without the need of a large conventional vertical stabilizer.

Yet another object of the present invention is to provide a lift generating fuselage for aircraft that reduces load on the wings and helps in reducing wing length.

Yet another object of the present invention is to provide a lift generating fuselage for aircraft that efficiently withstands bad weathers.

Yet another object of the present invention is to provide a lift generating fuselage for aircraft enhances the stability and maneuverability of the aircraft due to deployment of two integral vertical stabilizers and two rudders which operate in tandem.

Yet another object of the present invention is to provide a lift generating fuselage for aircraft that can further augment the lift generating capacity of the fuselage.

Yet another object of the present invention is to provide a lift generating fuselage for aircraft that offers maximum floor area for a given cubical volume.

Yet another object of the present invention is to provide a lift generating fuselage for aircraft that can enable easy detachment of fuselage from rest of the airframe in the event of emergency.

Yet another object of the present invention is to provide a lift generating fuselage for aircraft that has lower tare weight.

Yet another object of the present invention is to provide a lift generating fuselage for aircraft that has lower engine power requirement and thereby reducing the fuel consumption of the aircraft.

Yet another object of the present invention is to provide a lift generating fuselage for aircraft that has optimum internal space utilization.

### BRIEF DESCRIPTION OF DRAWINGS

FIG. 1: Shows lift generating fuselage according to the first embodiment of the present invention

FIG. 2: Shows the basic aerofoil profile structure of the present invention common to all the three embodiments.

FIG. 2A: Shows the perspective view of the present lift generating fuselage for aircraft according to the second embodiment of the present invention.

FIG. 2B: Shows the side view of the present lift generating fuselage for aircraft according to the second embodiment of the present invention.

FIG. 2C: Shows the cross sectional view of the present lift generating fuselage for aircraft according to the second embodiment of the present invention which is common to the third embodiment also.

FIG. 3: Shows the perspective view of the third embodiment of the present lift generating fuselage with integral webs and a overhead central wing.

FIG. 3A: Shows the side view of the third embodiment of the present lift generating fuselage with integral webs and a overhead central wing.

FIG. 3B Shows the preferred third embodiment of the present invention showing present lift generating fuselage for aircraft fitted with wings at bottom surface level forming a complete aircraft.

FIG. 3C: Shows the preferred third embodiment of the present invention showing present lift generating fuselage for aircraft fitted with wings in line with the overhead central wing forming a complete aircraft.

FIG. 4A: Shows the top, front and the side view of the conventional aircraft fuselage having a tubular or hollow pipe shape from front to back, tapering off into conical shape at front & rear ends.

FIG. 4B: Graph showing reduction in direct operating costs (DOC) per passenger and also relieve congestion on large airports by decreasing the number of flights by the Flying Wing (Prior Art)

FIG. 4C: Shows the structure of Flying Wing (Prior Art)

### MEANING OF REFERENCE NUMERALS OF SAID COMPONENT PARTS OF PRESENT IMPROVED INHALER (I)

| Reference | |
|---|---|
| numeral | Meaning of component parts |
| 1 | Present lift generating fuselage for aircraft |
| 1A | present novel aerofoil shaped fuselage |
| 1B | Present lift generating fuselage for aircraft with |
| | integral webs |
| 1C | Present lift generating fuselage for aircraft with |
| | integral webs and overhead central wing |
| 2 | Basic aerofoil shaped body of lift generating |
| | fuselage |
| A | Direction of Flight |
| B | Direction of Air Flow |
| 2A | Leading Edge |
| 2B | Trailing Edge |
| 2C | Side Walls |
| 2D | Upper Surface (roof) |
| 2E | Leading Edge Radius |
| 2F | Trailing Edge Radius |
| 2G | Chord |
| 2H | Camberline |
| 2I | Lower surface (bottom) |
| 2J | Front portion |
| 2K | Mid section |
| 2L | Rear Section |
| 2M | Cross section |
| 2N | Height |
| 2O | Width |
| 2P | Inner space |
| 3 | Flow Separating Webs |
| 3A | Pair of Vertical stabilizers |
| 3B | Twin Rudders |
| 4 | Overhead Central Wing |

### DETAILED DESCRIPTION OF THE INVENTION

The present invention embodies a lift generating fuselage for aircraft (1) that maximizes the lift factor thereby significantly decreases the length of runway required for the take off/landing of the aircraft, that enables the aircraft to land and takeoff directly from water surface making it a amphibious aircraft. Moreover, it provides lift generating fuselage for aircraft that keeps the aircraft airborne and efficiently withstands bad weathers.

The preferred embodiments of the present lift generating fuselage for aircraft (1) encompass:
a novel aerofoil shaped fuselage (1A); and
an improved lift generating fuselage for aircraft with integral webs (1B);
an improved lift generating fuselage for aircraft with integral webs and overhead central wing (1C).

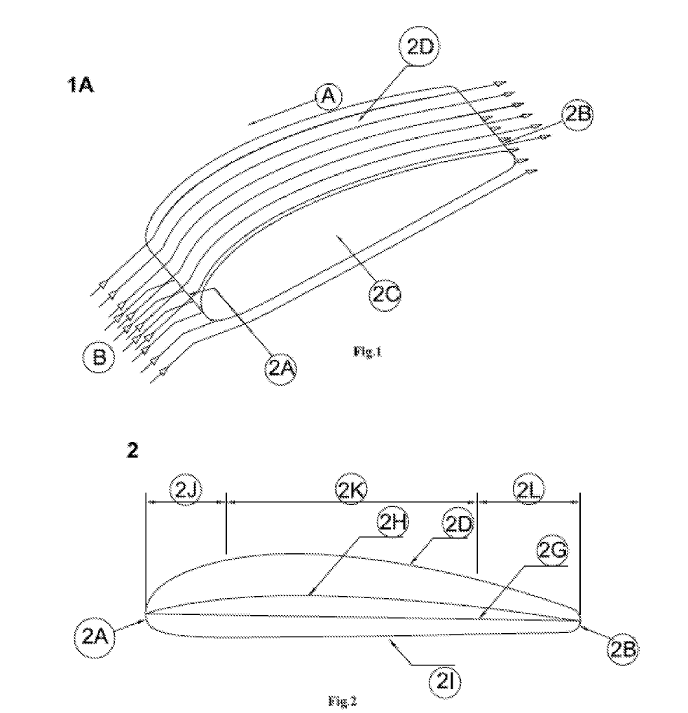

Said novel aerofoil shaped fuselage (1A) as shown in FIG. 1 is the basic structure of the present lift generating fuselage for aircraft in accordance with the first embodiment of the present invention. Said lift generating fuselage for aircraft has aerofoil shape for its longitudinal section. The chord of the aerofoil (2G) of the present novel aerofoil shaped lift generating fuselage (1A) for aircraft is maximum at the longitudinal centre line of the fuselage and reduces as one moves sideways away from the centre line on either side as clearly shown in FIG. 1. The resultant shape is almost like a bilaterally swept wing of an aircraft. Said shape causes the air flowing over its upper surface (2D) to travel at much higher speed than the speed of the aircraft itself thereby creating a low pressure zone over its upper surface. The air travelling underneath the lower surface (2I) is relatively slower and hence a higher pressure prevails at the bottom surface. This pressure differential causes an upward force on the fuselage which is nothing but the lifting force.

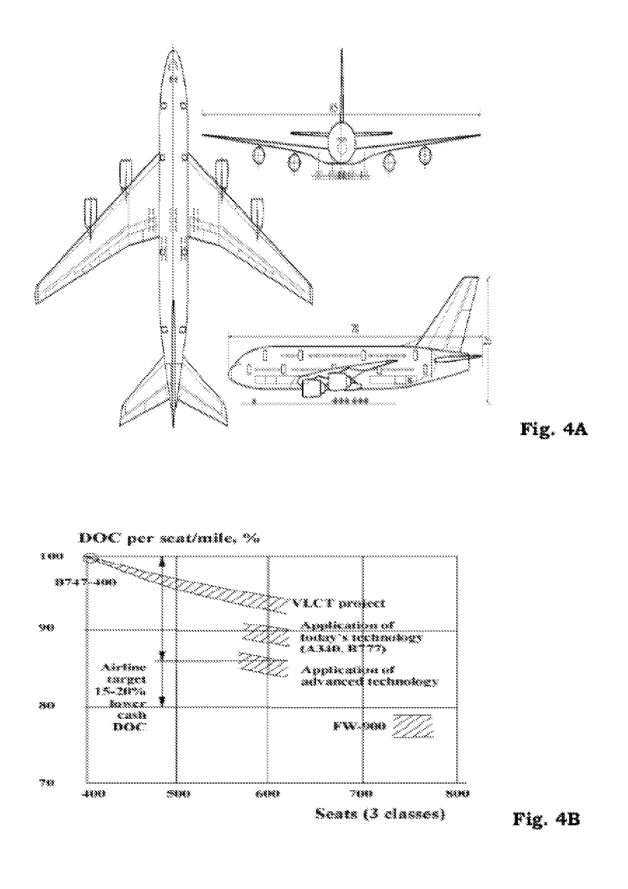

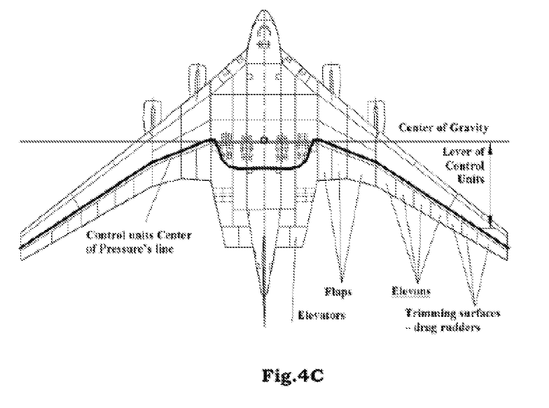

Thus, the present novel aerofoil shaped fuselage (1A) generates lift unlike that of the tubular shaped conventional aircraft shown in FIG. 4A. This said novel aerofoil shaped fuselage (1A) considerably reduces loads on the wings enabling to design shorter wings for the aircraft using said novel aerofoil shaped fuselage (1A) unlike that of the conventional fuselages. It also greatly reduces the bending moment at wing-fuselage intersection enabling it to bear bad weathers unlike that of the conventional aircrafts. In addition, it improves the lift to drag ratio of the aircraft compared to the conventional ones. Further, it reduces take off/landing speeds of the aircraft enabling the aircraft to operate at smaller runways and enhancing the safety of aircraft during take off as well as landing. It also reduces engine power requirement and thereby reduces fuel consumption. Having a rectangular cross section of the aircraft, it offers maximum space utilization unlike that of circular cross section of the conventional aircrafts.

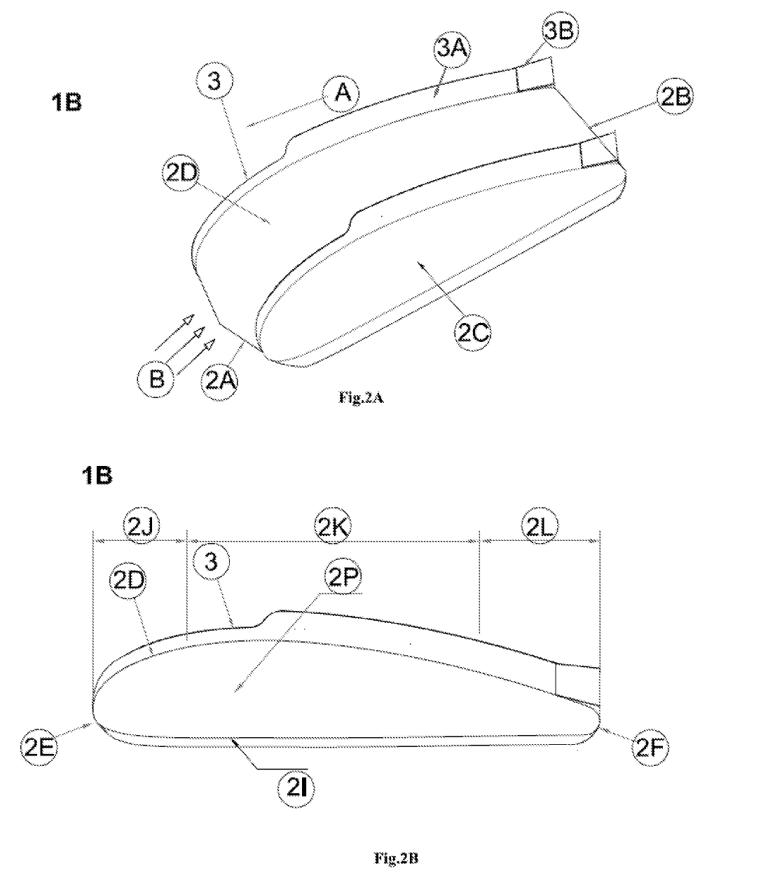

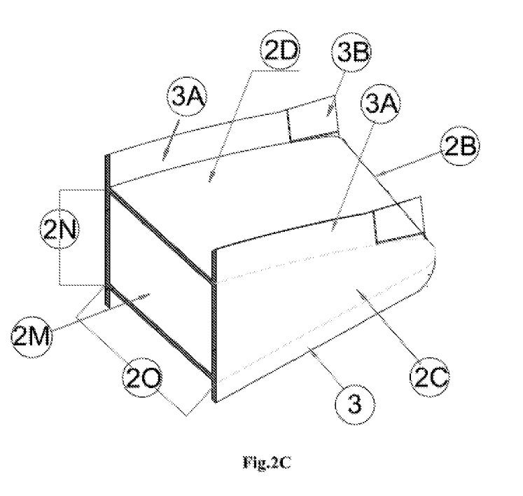

Second embodiment of the present invention is to provide an improved lift generating fuselage for aircraft with integral webs (1B) as shown in FIGS. 2A, 2B and 2C. According to said embodiment of the present invention, the aerofoil shape of the lift generating fuselage is provided with integral flow separating webs (3) that extend throughout the edge of the side walls (2C) which enhances in height from leading edge (2A) towards trailing edge (2B). Said height enhanced portion of the flow separating webs (3) becomes vertical stabilizer (3A) for the present improved lift generating fuselage for aircraft with integral webs (1B) eliminating the requirement of long single vertical stabilizer to be placed towards the trailing edge (2B) of the fuselage as that of conventional fuselages shown in FIG. 4A. This further eliminates the requirement of heighted hangers and the costs required for the infrastructure of said large hangers. Said pair of vertical stabilizers (3A) provide a greater stability to the aircraft against Yaw movement. Also because of their lower height as compared to conventional vertical stabilizers the overall height of the aircraft is much reduced, resulting in lower roof height requirement at the hangers. Further, said flow separating webs (3) physically separate the airflow over the surface of present improved lift generating fuselage for aircraft with integral webs (1B) and the adjacent free stream air. Due to this the tip vortices are significantly reduced and the laminar nature of flow is retained over a significant length of the present improved lift generating fuselage for aircraft with integral webs (1B). Thus the lift coefficient is enhanced and the drag coefficient is reduced, resulting in a much improved lift to drag ratio of the fuselage. In addition, portions of said pair of vertical stabilizers (3A) towards the tail end of present improved lift generating fuselage for aircraft with integral webs (1B) is converted into rudders (3B) which is by inserting a hinge into the surface. These twin rudders (3B) operate in tandem and provide a much better control of the aircraft during turning.

Said second embodiment of the present invention i.e. the present improved lift generating fuselage for aircraft with integral webs (1B) also imparts the advantages of the first embodiment, over the conventional fuselages. In addition to that having integral webs, pair of short heighted vertical stabilizers and twin rudders impart advantages of enhancing of lift coefficient and reduction of drag coefficient, reduces the infrastructural costs of the airports as the height of the hangers required will be less due to the short height of the said vertical stabilizers, offers greater stability and manoeuvrability, respectively.

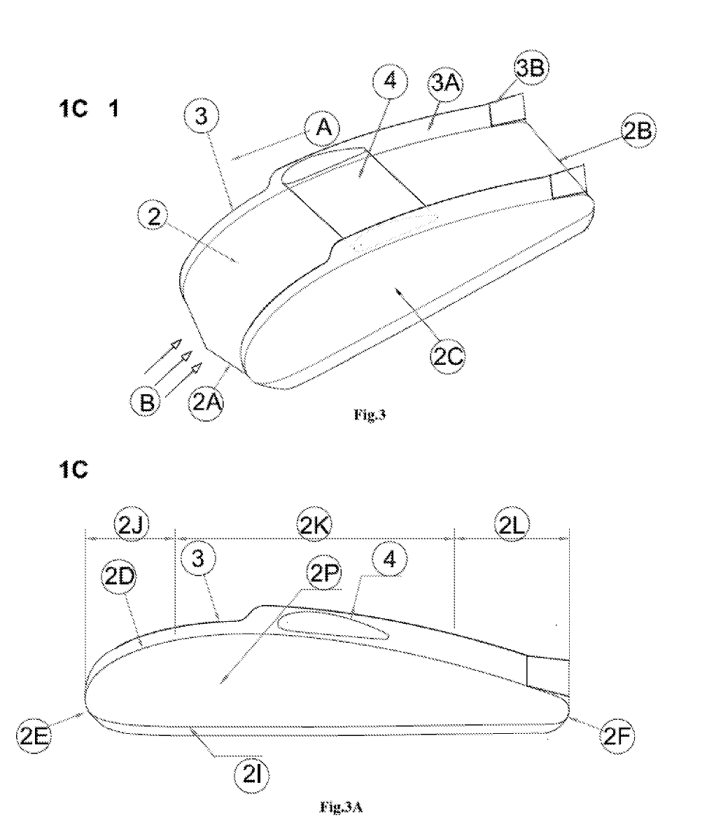

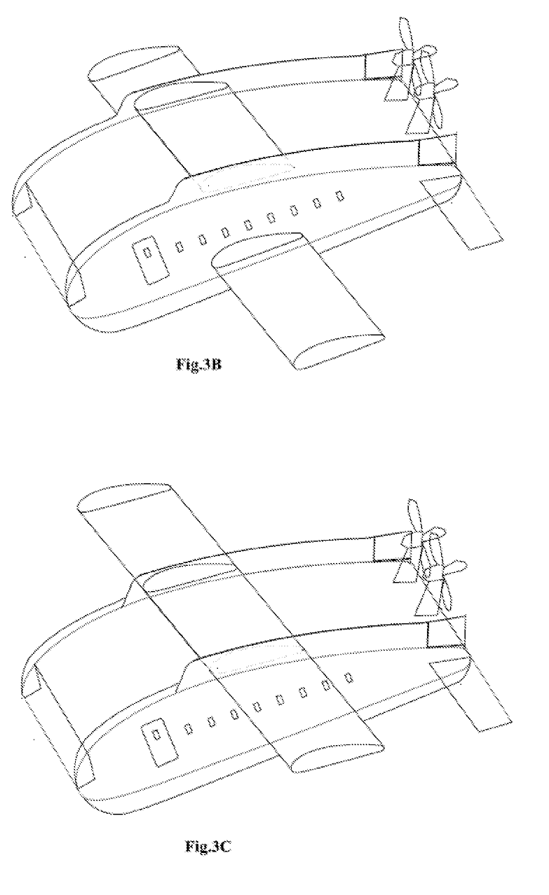

The third embodiment of the present invention is to provide an improved lift generating fuselage for aircraft with integral webs and overhead central wing (1C) as shown in FIGS. 3, 3A, 3B and 3C. Said embodiment of the present invention comprises of aerofoil shaped fuselage (2), integral webs at the side walls of the fuselage (3), and an overhead wing (4). Said aerofoil shaped fuselage (2) imparts the advantages of said first embodiment of the present invention, said integral webs (3) imparts the additional advantages of the second embodiment and the overhead wing (4) imparts the advantage of generating further lift. This is because the air approaching the central wing (4) is at a much higher velocity than the free stream velocity due to the aerofoil effect induced by the main body of the fuselage (2). Thus, the central wing (4) produces a greater lift than the other two wings which are subjected to free stream air flow. Also because the overhead wing (4) is placed between the two vertical flow separator (3) surfaces it is much more efficient aerodynamically as the tip vortices are avoided at both the ends.

Further present lift generating fuselage (1), unlike in Flying Wing (FW) or in Blended Wing Body (BWB) the distinctness of fuselage is maintained in the invention hence in the event of a crisis such as fire or damage in the wings which carry fuel tanks it becomes easy to detach the fuselage from the rest of the airframe and safe land it by deploying a parachute or other decelerating devices which may be invented in future.

FIGS. 3B and 3C specifically illustrates the complete aircraft made by using present lift generating fuselage 1C with different wing locations. For making the aircraft, the present lift generating fuselage for the aircraft (1) is equipped with two regulation wings and two horizontal stabilizers and the regulation pair of elevators apart from engine/s and propeller/s.

In case of a conventional fuselage construction the entire load of the aircraft is on the wings; while in case of the present lift generating fuselage for the aircraft (1), the present lift generating fuselage for the aircraft (1) itself takes away approximately 50% of the total aircraft load hence the wing loading is drastically reduced permitting the use of shorter wings. Thus, the aircraft made using present lift generating fuselage for the aircraft (1) has shorter wings compared to that of conventional fuselages thereby overcoming the disadvantages of large wings as described herein above. That is it in turn reduces the bending moment experienced at the wing-fuselage junction and enhances the structural safety of the aircraft in the event of extreme turbulence in the atmosphere. Also, the load bearing beams within the wings which are known as spars become lighter with the present lift generating fuselage for the aircraft (1) resulting in reduction of tare weight of the aircraft. With the present lift generating fuselage for the aircraft (1) there will be no mandatory reaction fuel, which is the minimum fuel that must be retained in the fuel tanks at all times in order to counter unacceptable level of upward deflection. This is a further saving in idle weight.

In addition, with the present lift generating fuselage for the aircraft (1) the wings can be located at the level flush with the bottom surface as shown in FIG. 3B or also at level flush with the central wing as shown in FIG. 3C. Both the constructions are aerodynamically suitable but if the aircraft is designed for take off/lading from water surface also, the configuration shown in FIG. 3C is preferable as it keeps the wings completely off the water surface.

The cavernous wide space available towards the tail end of the present lift generating fuselage for the aircraft (1) opens up the possibility of deploying in board engines within the fuselage with suitable vibration and noise absorbing systems. Such a dispensation is shown in FIGS. 3B and 3C whereby the propellers are located at the tail end of the lift generating fuselage (1). This again is a feature with enhanced safety implications.

### ADVANTAGES OF THE PRESENT INVENTION

1. Present lift generating fuselage for aircraft that maximizes the lift factor thereby augmenting the force keeping the aircraft airborne due to its aerofoil type shape.
2. Present lift generating fuselage for aircraft significantly decreases the length of runway required for the take off/landing of the aircraft.
3. Present lift generating fuselage for aircraft enables the aircraft to land and takeoff directly from water surface making it an amphibious aircraft.
4. Present lift generating fuselage for aircraft enables the aircraft to land and takeoff at significantly lower speeds.
5. Present lift generating Fuselage reduces the velocities of the aircraft at the time of takeoff and landing. This greatly reduces the length of the runway required at the airport. Thus the infra structure requirement in terms of land, boundary walls, security and maintenance is also proportionately reduced. This is also one of the objectives of the invention.
6. Present lift generating fuselage for aircraft has higher safety of the aircraft during takeoff and landing by reducing the takeoff and landing speeds. The safety of the aircraft is enhanced due to lower take off and landing speeds. Thus, an aircraft is at a much lower risk if any untoward incident like tyre burst or skidding or unexpected obstruction etc. occurs on the runway at the time of take off/landing.
7. Present lift generating fuselage for aircraft stabilizes the aircraft without the need of a large conventional vertical stabilizer.
8. Present lift generating fuselage for aircraft reduces the wing loading of the aircraft and also reduces wing length thereby significantly reducing the stresses at the wing-fuselage junction as well as chances of wing distortion or warping.
9. Present lift generating fuselage for aircraft efficiently withstands bad weathers.
10. Present lift generating fuselage for aircraft enhances the stability and maneuverability of the aircraft due to deployment of two integral vertical stabilizers and two rudders which operate in tandem.
11. Present lift generating fuselage for aircraft is equipped with an extra wing above the upper surface of the fuselage capsule as an integral part which can further augment the lift generating capacity of the fuselage.
12. Present lift generating fuselage for aircraft offers maximum floor area for a given cubical volume.
13. Present lift generating fuselage for aircraft enable easy detachment of fuselage from rest of the airframe in the event of emergency.
14. Present lift generating fuselage for aircraft has lower tare weight. As the lift generating Fuselage reduces load on the wings the structural members of the wings known as spars can be designed lighter. This reduces the overall weight of the aircraft for a given payload capacity.
15. Present lift generating fuselage for aircraft helps reduce the engine power requirement and hence reduce the fuel consumption. As the lift generating Fuselage is generating the lift, the overall lift to drag ratio of the aircraft greatly improves. Thus, the propulsive thrust required becomes lower resulting in reduced engine power requirement and hence reduced fuel consumption by the aircraft. Due to this the aircraft has to carry less quantity of fuel for a given trip and so the overall load to be carried also reduces. This results in significant improvement in fuel consumption per unit of payload per distance travelled.
16. Present lift generating fuselage for aircraft enables construction of aircraft with much shorter length for accommodating the same payload in terms of passengers, cargo and housing all standard equipments of an aircraft. Overall, the design offers the advantage of greater availability of cubic volume for a given length of the aircraft. Also due to its rectangular cross section it makes it easy to design the internal layout of the aircraft with optimum space utilization. Thus improved space utilization is another objective of the invention.

1. The present lift generating fuselage (1) for aircraft mainly comprises of:
a novel aerofoil shaped fuselage (1A); or
a novel aerofoil shaped fuselage body (2); and integral webs (3); or
a novel aerofoil shaped fuselage body (2); integral webs (3) and overhead central wing (4);
wherein:
said integral flow separating webs (3) that extend throughout the edge of the side walls (2C) which enhances in height from leading edge (2A) towards trailing edge (2B);
said height enhanced portion of the flow separating webs (3) forms pair of vertical stabilizer (3A);
wherein further portions of said pair of vertical stabilizers (3A) towards the tail end of present improved lift generating fuselage for aircraft with integral webs (1B) is converted into rudders (3B) which is by inserting a hinge into the surface;
wherein further said overhead central wing (4) is placed between the two vertical flow separator (3).
